(19) United States
(12) Patent Application Publication
(10) Pub. No.: US 2017/0322140 A1
(43) Pub. Date: Nov. 9, 2017

(54) Preparation of tyndallized, intact and immunologically active cells of Lactobacillus rhamnosus GG and method for qualitative and quantitative determination thereof

(71) Applicant: PROBIOTICAL S.p.A., Novara (NO) (IT)

(72) Inventor: Giovanni MOGNA, Novara (NO) (IT)

(73) Assignee: PROBIOTICAL S.p.A., Novara (NO) (IT)

(21) Appl. No.: 15/524,982

(22) PCT Filed: Nov. 12, 2015
(86) PCT No.: PCT/IB2015/058747

§ 371 Date: May 5, 2017

(30) Foreign Application Priority Data
Nov. 12, 2014 (IT) 102014902308600

(51) Int. Cl. G01N 15/14; G01N 21/64

(52) U.S. Cl. CPC G01N 15/1459; G01N 21/645; G01N 21/6486; G01N 21/6428; G01N 2015/1486; G01N 2015/1488; G01N 2021/6441; G01N 2015/1402

(57) ABSTRACT

Tyndallized, intact and immunologically active bacterial cells of Lactobacillus rhamnosus GG (ATCC 53103) is described. A method for preparing the same, as well as an analytical method for the qualitative and quantitative determination of tyndallized, intact and immunologically active bacterial cells of Lactobacillus rhamnosus GG (ATCC 53103) is also described.

The present invention relates to tyndallized, intact and immunologically active bacterial cells of Lactobacillus rhamnosus GG (ATCC 53103); a method for preparing the same, as well as an analytical method for the qualitative and quantitative determination of tyndallized, intact and immunologically active bacterial cells of Lactobacillus rhamnosus GG (ATCC 53103).

The technique for producing tyndallized spores or bacteria is well-known. Tyndallization is a fractional sterilization method, wherein the heating to temperatures of 80-100° C. for 30 minutes is applied in batch mode. A first thermal treatment, which kills vegetative forms, is followed by an incubation period of 24 hours, promoting spore germination. The so-treated material is brought back to a temperature of 80-100° C. for 30 minutes, in order to kill the vegetative cells deriving from spore germination. These procedures should be repeated 2 or 3 times. Tyndallization is used for substances which do not tolerate high temperatures, such as for example spores or lactic bacteria.

Tyndallized bacterial cells are those with an inactivated replication capacity and an inactivated enzymatic capacity. However, tyndailized cells maintain unmodified their cell structure and cell wall. Therefore, tyndallized bacterial cells can be defined as, from the point of view of their activity, physiologically intact cells and, for this reason, they are immunologically active. This implies that tyndallized intact cells maintain their specific immunostimulatory activity towards GALT.

By Gut-Associated Lymphoid Tissue, also known as GALT, is usually meant the portion of the immune system existing at the digestive tract level. GALT is an example of mucosa-associated lymphoid tissue, which is responsible for the protection of mucosae against pathogen attacks, both in the primary and secondary responses. Indeed, the gastrointestinal system represents a communication pathway with the external environment and is mainly inhabited by potentially pathogenic microorganisms (specifically the intestine), whereby a strong presence of the immune system at mucosal level for ensuring the control of such populations is required.

Among the most investigated strains of lactic bacteria there is, undoubtedly, Lactobacillus rhamnosus GG ATCC 53103 which, due to its extraordinary immunostimulatory properties/activities, is effectively used in many formulations for human and pediatric use. However, thus far, no formulation containing tyndallized bacterial cells of Lactobacillus rhamnosus GG (ATCC53103) exists. This is due to the fact, among others, that to date there is no possibility to determine the exact number of tyndallized, intact cells existing in a sample of bacterial cells.

Therefore, it would be very useful to being able to determine the exact number of tyndallized bacterial cells having intact and immunologically active cells present in a sample (cells with unmodified cell wall) by an analytical method being fast, reliable and totally reproducible. Furthermore, it would also be essential to being able to ensure that the determined number of tyndallized, intact and immunologically active cells corresponds to the number actually present in the tested tyndallized sample, in order to ease their administration, ensure the reproducibility of the used dosages, extend the shelf-life even at temperatures of 30° C. allowing the shipping of bacterial cells of Lactobacillus rhamnosus GG (ATCC 53103) to warmer countries and facilitate the processing of said bacterial cells into final products (formulations).

However, a method for producing a culture of tyndallized, intact and immunologically active bacterial cells of Lactobacillus rhamnosus GG (ATCC 53103) having a cell number determined in a fast, accurate, reliable and totally reproducible manner is presently unavailable.

Therefore, there is still a need to have a method for producing a culture of tyndallized, intact and immunologically active bacterial cells of Lactobacillus rhamnosus GG (ATCC 53103); said culture having an accurate, reliable and totally reproducible number of cells. Moreover, there is still a need to have an analytical method which allows to count, in a fast, accurate, reliable and totally reproducible manner, only the intact bacterial cells of Lactobacillus rhamnosus GG (ATCC 53103) having an unmodified cell wall so that to maintain their intrinsic ability of the immune system.

It is an object of the present invention a culture of tyndallized, intact and immunologically active bacterial cells of Lactobacillus rhamnosus GG (ATCC 53103), as set forth in the appended claim; said culture having an accurate, reliable and totally reproducible concentration value of tyndallized bacterial cells.

It is an object of the present invention a method for preparing said tyndallized, intact and immunologically active bacterial cells of Lactobacillus rhamnosus GG (ATCC 53103), as set forth in the appended claim; said method being fast, accurate, reliable and totally reproducible.

It is an object of the present invention an analytical method for the qualitative and quantitative determination of tyndallized, intact and immunologically active bacterial cells of Lactobacillus rhamnosus GG (ATCC 53103) being present in a bacterial cell culture of Lactobacillus rhamnosus GG (ATCC 53103) previously prepared and subsequently subjected to tyndallization, as set forth in the appended claim.

It is an object of the present invention the use of flow cytofluorometry for counting the dead but intact cells being present in a sample of tyndallized bacterial cells of Lactobacillus rhamnosus GG (ATCC 53103), as claimed in the appended claim.

Preferred embodiments of the present invention will be described hereinafter in the description.

The present invention firstly contemplates the preparation of a bacterial cell culture of Lactobacillus rhamnosus GG (ATCC 53103) for example in a solid form such as a dry, dehydrated or freeze-dried culture having a concentration comprised from 1×10⁶ to 1×10¹⁰ UFC/g, preferably from 1×10⁷ to 1×10⁵ UFC/g. The culture is prepared according to techniques and devices known to the skilled in the field. Once the bacterial cell culture is prepared, this is subjected to a tyndallization process, according to techniques known to the skilled person, in order to obtain a culture of tyndallized bacterial cells.

Then, in order to quantify the tyndallized, intact and immunologically active bacterial cells, the Applicant developed an innovative analytical counting method for the qualitative and quantitative determination of tyndallized bacterial cells which is effectively applied for Lactobacillus rhamnosus GG (53103) and based on the use of cytofluorometry.

The Applicant applies flow cytofluorometry to a sample of tyndallized, intact bacterial cells of Lactobacillus rhamnosus GG (ATCC 53103), said sample being obtained by known techniques and devices for tyndallization.

The claimed method is useful for a fast and accurate computation of bacterial cells of Lactobacillus rhamnosus GG (ATCC 53103) which, upon their preparation by techniques and devices known to the skilled in the field, are subjected to a tyndallization process, performed with techniques and devices known to the skilled in the field, which inactivates their replication capacity and their enzymatic capacity. The method has been developed by the Applicant since the traditional counting methods do not allow to quantify the dead bacterial cells of Lactobacillus rhamnosus GG (ATCC 53103) present in a tyndallized biological sample and, at the same time, do not allow to ensure a sample of bacterial cells having a well established and reproducible biological activity (stimulation of immune system and/or bioactive peptides). Advantageously, the procedure is successfully applicable to bacterial cells of Lactobacillus rhamnosus GG (ATCC 53103), which are unable to replicate, but having a structural integrity at the cell wall level.

The method of the present invention contemplates a series of steps, which will be described in more detail hereinafter in the description.

For the first time, flow cytofluorometry for counting tyndallized, intact bacterial cells of Lactobacillus rhamnosus GG (ATCC 53103) is applied.

Therefore, it is an object of the present invention the use of cytofluorometry for producing, counting and determining the number of bacterial cells of Lactobacillus rhamnosus GG (ATCC 53103) and their biological activity in a tyndallized sample.

Flow cytometry provides a fast and reliable method for quantifying viable/dead cells present in bacterial suspensions. Through cytofluorometric analysis, it is possible to discriminate in a biological sample, such as for example a bacterial cell culture, between live and dead cells taking advantage from the combination of the specific dyes contained in the “BD™ Cell viability” kit (marketed by Becton Dickinson Company) which specifically investigates the integrity of the cell wall.

The commercially available kit contains a first staining reagent such as thiazole orange (TO) being able to label all the cells, both live and dead, and a second staining reagent such as propidium iodide (PI) specific for dead cells.

For the quantitative cell determination it is essential to associate with the above-described kit the suspension of fluorescent beads “BD™ Liquid Counting Beads”, marketed by Becton Dickinson Company. The bead suspension is a suspension of fluorescent polystyrene microspheres in a 0.1% solution of sodium azide.

The addition of a known amount of beads, comprised from 10 to 100 μl, preferably from 40 to 60 μl, allows to determining the absolute cell count by extrapolating the collected data.

Live cells having an intact cytoplasmic membrane result impermeable to dyes, such as propidium iodide (PI). Conversely, dyes such as propidium iodide (PI) can enter the cells with an impaired cytoplasmic membrane. Thiazole orange (TO) is a dye able to enter all the cells, both live and dead. The combination of these two staining reagents provides a fast and reliable method for discriminating bacterial cells, both live and dead, with structural integrity.

It is important to perform a preliminary step for conditioning the reagents and the tested sample,

Therefore, the procedure is as follows:
Bringing all the kit reagents to room temperature before their use.
Leaving the biological sample containing the bacterial cells at room temperature for 1-6 hours, preferably from 1.5 to 3 hours, for example from 2 to 2.5 when stored at a temperature of minus 20° C., for about 60 minutes, for example 30 minutes when stored at +4° C.
Placing the suspension containing the beads under slow and gentle stirring.

Next, the preparation of a bacterial cell culture of Lactobacillus rhamnosus GG (ATCC 53103) and the subsequent tyndallization thereof to obtain a culture of tyndallized bacterial cells, for example in a solid form such as a dry, dehydrated or freeze-dried culture having a concentration comprised from 1×10⁶ to 1×10¹⁰ UFC/g, preferably from 1×10⁷ to 1×10⁹ UFC/g is performed.

Then, the preparation of the test sample is conducted.
In the case of a sample in liquid form, make serial dilutions 1:10 in 0.1% sterile peptone saline until the achievement of a concentration rate of about 10⁵-10⁷ cells/ml.
In the case of an anhydrous sample, reconstitute the sample 1:10 in a sterile bag and stomaching the whole in order to homogenize the preparation. Then, subsequent dilutions 1:10 such as in the case of samples in liquid form are performed.

Next, the analysis of the amount of live/dead cells by using cytofluorometry is carried out.

As regards the dying step, the procedure is as follows:
Adding to 0.5 ml of the suitable dilution 2.5 μl of thiazole orange TO and 1.5 μl of propidium iodide PI, stirring and incubating for 2 minutes at room temperature; and
Adding 50 μl of suspension containing beads and subjecting the sample to cytafluorometric analysis.

Then, the acquisition and analysis of the data is performed.

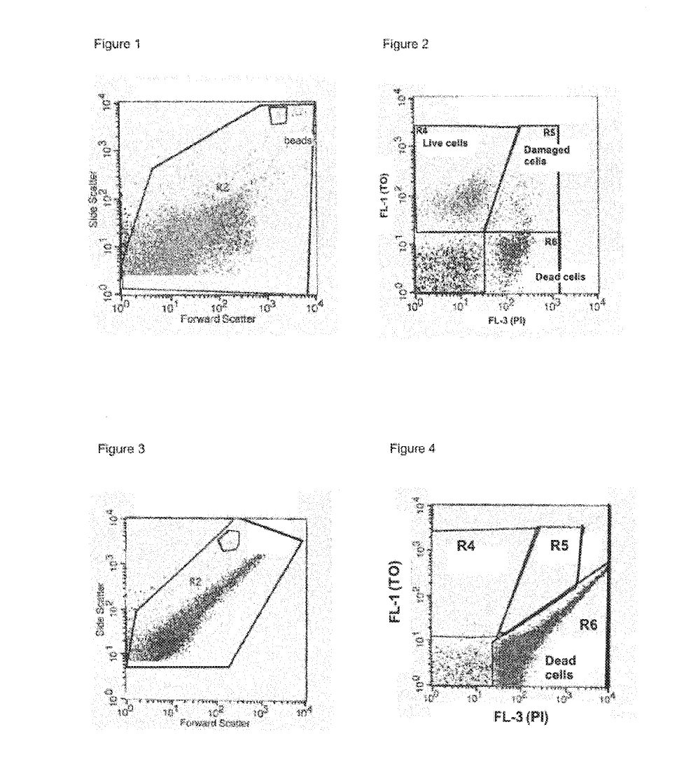

A cytogram, wherein the x-axis represents the Forward scatter (FSC) and the y-axis the Side Scatter (SSC), in order to delimiting the population to be analyzed (R2, See FIG. 1) is set up.

For a proper visualization of cell subpopulations being differentiated based on the internalization of the used dyes, a second cytogram, wherein the x-axis represents FL-1 (TO, see FIG. 2) and the y-axis FL-3 (PI, see FIG. 2) is set up.

FIG. 1 relates to a FSC vs SSC cytogram, whereas FIG. 2 relates to a FL1 vs FL3 cytogram.

Next, the computation and expression of the results is performed.

In order to determine the number of dead bacterial cells in the sample, the following formula is used.

$$\begin{matrix}dead cell number = \frac{cell no . in R 6}{Bead no .} \times \frac{beads / batch *}{Sample volume} \times D . F . \\ & \\ (* ) the value to be applied is that reported on the packaging of the beads being used and differs among batches ; D . F . = dilution factor & \end{matrix}$$

The result is expressed as the number of cells/ml for samples in liquid form, or the number of cells/g for samples in anhydrous form.

By using the above formula, and the cellular events delimited by the region (R6), the number of dead cells being present in the sample is obtained.

Dead, but with structural integrity, cells are expressed as the number of cells/ml for samples in liquid form, or the number of cells/g for samples in anhydrous form.

An embodiment relates to a method for counting the number of dead cells having an intact cell membrane in a sample of tyndallized bacterial cells of Lactobacillus rhamnosus GG (ATCC 53103); said method comprises:
preparing a sample containing tyndallized bacterial cells of Lactobacillus rhamnosus GG (ATCC 53103) having a concentration comprised from 10⁵ to 10⁷ cells/ml, by serial dilution;
adding to said sample a first reagent thiazole orange and a second reagent propidium iodide for obtaining a solution;
adding to said solution a suspension of fluorescent microspheres in sodium azide for obtaining a test sample;
subjecting said test sample to total cell count, comprising live cells and dead cells, and to the count of the dead cells alone by flow cytofluorometry;
counting the dead cells being present in the tyndallized sample.

Preferably, said method further contemplates that to 0.5 ml of a sample containing tyndallized bacterial cells of Lactobacillus rhamnosus GG (ATCC 53103) having a concentration comprised from 10⁵ to 10⁷ cells/ml 2.5 microliters of said first reagent and 1.5 microliters of said second reagent are added to obtain a solution.

Preferably, said method further contemplates that the suspension of fluorescent microspheres in sodium azide comprises polystyrene microspheres, preferably the bead suspension is a suspension of fluorescent polystyrene microspheres in a 0.1% solution of sodium azide.

Preferably, said method further contemplates the addition of a known amount of beads, comprised from 10 to 100 μl, preferably from 40 to 60 μl, for allowing the cell count determination.

Another embodiment relates to a method for producing tyndallized bacterial cells of Lactobacillus rhamnosus GG (ATCC 53103) with intact cell wall; said method comprises:
preparing a bacterial cell culture of Lactobacillus rhamnosus GG (ATCC 53103) having a concentration comprised from 1×10⁶ to 1×10¹⁰ UFC/g;
subjecting said culture to a tyndallization process to obtain a culture of tyndallized bacterial cells;
applying the above-described counting method.

Another embodiment relates to a culture of tyndallized, intact and immunologically active bacterial cells of Lactobacillus rhamnosus GG (ATCC 53103) obtained by the method for producing bacterial cells as described above.

Another embodiment relates to the use of flow cytofluorometry for counting the number of tyndallized, dead bacterial cells of Lactobacillus rhamnosus GG (ATCC 53103) having an intact cell membrane in a sample of tyndallized bacterial cells of Lactobacillus rhamnosus GG (ATCC 53103).

Preferably, said use contemplates that said tyndallized, dead bacterial cells of Lactobacillus rhamnosus GG (ATCC 53103) having an intact cell membrane are counted with a counting method as described above.

An experimental example, performed on bacterial cells of Lactobacillus rhamnosus GG (ATCC 53103), is shown hereinbelow (values expressed as bn/g):

| | |
|---|---|
| pre- | post |
| tyndallization | tyndallization |

| SAMPLES | live | dead | live | dead |
|---|---|---|---|---|
| 1 | 211 | 137 | 0.001 | 179 |

FIG. 3 relates to a FSC vs SSC cytogram of said sample, whereas FIG. 4 relates to a FL1 vs FL3 cytogram of said sample.

The cytofluorometer and the kit being used have the following specifications.
Flow cytometer FACSCalibur 3CA (Becton Dickinson Italia, cat No 343020) equipped with 488 nm laser excitation and its CellQuest™ software.
BD™ Cell Viability Kit with BD Liquid Counting Beads (cat No 34948).

1. A method for counting the number of dead cells having an intact cell membrane in a sample of tyndallized bacterial cells of Lactobacillus rhamnosus GG (ATCC 53103), the method comprising:
preparing a sample containing tyndallized bacterial cells of Lactobacillus rhamnosus GG (ATCC 53103) having a concentration from 10⁵ to 10⁷ cells/ml, by serial dilution;
adding to said sample a first reagent thiazole orange and a second reagent propidium iodide to obtain a solution;
adding to said solution a suspension of fluorescent microspheres in sodium azide to obtain a test sample;
subjecting said test sample comprising live cells and dead cells to flow cytofluorometry; and
counting the dead cells being present in the test sample.

2. The method according to claim 1, wherein adding to said same a first reagent thiazole orange and a second reagent propidium iodide is performed by adding 2.5 microliters of said first reagent and 1.5 microliters of said second reagent to 0.5 ml of the sample containing tyndallized bacterial cells of Lactobacillus rhamnosus GG (ATCC 53103) having a concentration comprised from 10⁵ to 10⁷ cells/ml.

3. The method according to claim 1, wherein the suspension of fluorescent microspheres in sodium azide comprises polystyrene microspheres.

4. The method according to claim 3, wherein the suspension comprises a known amount of polystyrene microspheres, from 10 to 100 μl.

5. A method for producing tyndallized bacterial cells of Lactobacillus rhamnosus GG (ATCC 53103) having an intact cell wall, the method comprising:
preparing a bacterial cell culture of Lactobacillus rhamnosus GG (ATCC 53103) having a concentration from 1×10⁶ to 1×10¹⁰ UFC/g;
subjecting said culture to a tyndallization process to obtain a culture of tyndallized bacterial cells comprising live cells and dead cells;
counting the number of dead cells in said culture of tyndallized bacterial cells with the method according to claim 1.

6. A culture of tyndallized, intact and immunologically active bacterial cells of Lactobacillus rhamnosus GG (ATCC 53103) obtained by the method according to claim 5.

7. A method for counting the number of tyndallized, dead bacterial cells of Lactobacillus rhamnosus GG (ATCC 53103) having an intact cell membrane in a sample of tyndallized bacterial cells of Lactobacillus rhamnosus GG (ATCC 53103), the method comprising:
providing the sample of tyndallized bacterial cells of Lactobacillus rhamnosus GG (ATCC 53103); and
applying flow cytofluorometry to the sample.

8. The method according to claim 7, wherein
the providing the sample comprises
adding to said tyndallized, dead bacterial cells of Lactobacillus rhamnosus GG (ATCC 53103) having an intact cell membrane a first reagent thiazole orange and a second reagent propidium iodide to obtain a solution; and
adding to said solution a suspension of fluorescent microspheres in sodium azide to obtain a test sample; and
the applying flow cytofluoremetry comprises
subjecting said test sample to a total cell count by flow cytofluorometry, the total cell comprising live cells and dead cells;
subjecting said test sample to a count of dead cells alone by flow cytofluorometry; and
counting the dead cells being present in the test sample.

9. The method according to claim 8, wherein adding to said same a first reagent thiazole orange and a second reagent propidium iodide is performed by adding 2.5 microliters of said first reagent and 1.5 microliters of said second reagent to 0.5 ml of the sample containing tyndallized bacterial cells of Lactobacillus rhamnosus GG (ATCC 53103) having a concentration comprised from 10⁵ to 10⁷ cells/ml.

10. The method according to claim 8, wherein the suspension of fluorescent microspheres in sodium azide comprises polystyrene microspheres.

11. The method according to claim 10, wherein the suspension comprises a known amount of polystyrene microspheres, from 10 to 100 μl.

12. The method of claim 10, wherein the suspension comprises fluorescent polystyrene microspheres in a 0.1% solution of sodium azide.

13. The method of claim 11, wherein the known amount of polystyrene microspheres is from 40 to 60 μl.

14. The method of claim 3, wherein the suspension comprises fluorescent polystyrene microspheres in a 0.1% solution of sodium azide.

15. The method of claim 4, wherein the known amount of polystyrene microspheres is from 40 to 60 μl.
